(19) United States
(12) Patent Application Publication
(10) Pub. No.: US 2026/0260020 A1
(43) Pub. Date: Sep. 3, 2026

(54) SIGNAL PROCESSING DEVICE AND SIGNAL PROCESSING METHOD

(71) Applicant: Sony Semiconductor Solutions Corporation, Kanagawa (JP)

(72) Inventor: Kentaro Omata, Tokyo (JP)

(21) Appl. No.: 18/841,238

(22) PCT Filed: Mar. 6, 2023
(86) PCT No.: PCT/JP23/08367

§ 371 Date: Aug. 23, 2024

(30) Foreign Application Priority Data
Mar. 7, 2022 (JP) 2022-034752

(51) Int. Cl. G06F 21/64; G06F 21/60; H04L 9/08

(52) U.S. Cl. CPC G06F 21/64; G06F 21/602; H04L 9/0869

(57) ABSTRACT

Signal processing that prevents falsification of an image is disclosed. In one example, a signal processing device includes a second processing unit that transmits sensing data and first encryption information obtained by encrypting a part of the sensing data to a first processing unit.

The second processing unit includes a first encryption unit that generates the first encryption information by encrypting a part of data randomly selected from the sensing data according to a random number generation procedure shared with the first processing unit or adding authentication information to the part of data. The first processing unit includes a second encryption unit that generates second encryption information by encrypting a part of data randomly selected from the received sensing data or adding authentication information to the part of data, and a verification unit that verifies whether or not the first encryption information matches the second encryption information.

### TECHNICAL FIELD

The present disclosure relates to a signal processing device and a signal processing method.

### BACKGROUND ART

When an image captured by an in-vehicle image sensor is transmitted to an engine control unit (ECU), it is necessary to prevent falsification of the image (see Patent Document 1).

In order to prevent falsification of the image, it is desirable to add an authentication code to the image and transmit the image. Processing of adding an authentication code to an image, for example, a cipher-based message authentication code (CMAC) algorithm increases a processing load on a processor built in an image sensor or an ECU, and there is a possibility that electric control of a vehicle is disturbed.

### CITATION LIST

### Patent Document

Patent Document 1: WO 2018/230366 A

### SUMMARY OF THE INVENTION

### Problems to be Solved by the Invention

It is also conceivable that an authentication code is added to only a part of an image captured by the image sensor and transmitted to the ECU to perform image authentication. However, in a case where a position and a size of a partial region to which the authentication code is added in the image are common in each frame, there is a possibility that a region other than the partial region to which the authentication code is added in the image is falsified.

Furthermore, in a case where a partial region to be encrypted in the image is randomized for each frame, information on a position and a size of the encrypted partial region in the image needs to be correctly transmitted to a side of the ECU, and an amount of information transmitted and received between the image sensor and the ECU increases, and efficient data communication cannot be performed.

The present disclosure has been made in view of the above-described problems, and an object thereof is to provide a signal processing device and a signal processing method capable of efficiently preventing falsification of an image.

### Solutions to Problems

In order to solve the problem described above, in one aspect of the present disclosure, there is provided a signal processing device including: a first processing unit; and a second processing unit that transmits, to the first processing unit, sensing data and first encryption information obtained by encrypting a part of the sensing data, in which the second processing unit includes a first encryption unit that generates the first encryption information by encrypting a part of data randomly selected from the sensing data according to a random number generation procedure shared with the first processing unit or adding authentication information to the part of data, and the first processing unit includes: a second encryption unit that generates second encryption information by encrypting a part of data randomly selected from the sensing data received from the second processing unit according to the random number generation procedure or adding authentication information to the part of data; and a verification unit that verifies whether or not the first encryption information matches the second encryption information.

The first encryption unit and the second encryption unit may randomly select timings at which the first encryption information and the second encryption information are generated according to the random number generation procedure.

The first encryption unit may generate the first encryption information from a part of the sensing data acquired at a timing randomly selected according to the random number generation procedure, and the second encryption unit may generate the second encryption information from a part of the sensing data acquired at a timing randomly selected according to the random number generation procedure among the sensing data received from the second processing unit.

The first processing unit may acquire a plurality of the sensing data at a predetermined time interval, and the first encryption unit may generate the first encryption information by encrypting the part of data randomly selected from each of the plurality of sensing data or adding authentication information to the part of data.

The first processing unit may acquire a plurality of the sensing data at a predetermined time interval, and the first encryption unit may generate the first encryption information on the basis of sensing data at a time interval randomly selected from the plurality of sensing data.

The first encryption unit may generate the first encryption information by randomly selecting the part of data included in the sensing data at a time interval randomly selected from the plurality of sensing data.

The first processing unit may include a first random number generation unit that generates a first random number according to the random number generation procedure, the second processing unit may include a second random number generation unit that generates a second random number according to the random number generation procedure, the first encryption unit may generate the first encryption information on the basis of the first random number, and the second encryption unit may generate the second encryption information on the basis of the second random number.

The first random number generation unit may generate the first random number according to the random number generation procedure by using key information and a third random number shared between the first processing unit and the second processing unit, and
the second random number generation unit may generate the second random number according to the random number generation procedure by using the key information and the third random number.

The first processing unit may include: a third random number generation unit that generates the third random number; and a communication unit that transmits the third random number to the second processing unit.

The sensing data may include image data, and the first encryption unit may generate the first encryption information by encrypting the part of data included in the image data on the basis of the first random number or adding authentication information to the part of data.

The first processing unit may acquire a plurality of the image data at a predetermined time interval, and the first encryption unit may generate the first encryption information by randomly selecting image data at a partial time interval among the plurality of image data.

The first encryption unit may generate the first encryption information by encrypting the part of data randomly selected from the part of image data or adding authentication information to the part of data.

The first processing unit may include an imaging sensor that detects the image data.

The image data may include distance image data, and the first processing unit may include a distance measurement sensor that generates the distance image data.

At least one of the first random number generation unit and the second random number generation unit may be configured by hardware.

At least one of the first processing unit and the second processing unit may perform processing of at least one of the first random number generation unit and the second random number generation unit by software.

The second processing unit may have a stacked semiconductor chip structure in which at least two semiconductor chips are stacked.

According to another aspect of the present disclosure, there is provided a monitoring system including: a first processing device; and a second processing device that transmits, to the first processing device, sensing data and first encryption information obtained by encrypting a part of the sensing data or adding authentication information to the part of the sensing data, in which the second processing device includes a first encryption unit that generates the first encryption information by encrypting a part of data randomly selected from the sensing data according to a random number generation procedure shared with the first processing device, and the first processing device includes: a second encryption unit that generates second encryption information by encrypting a part of data randomly selected from the sensing data received from the second processing device according to the random number generation procedure or adding authentication information to the part of data; and a verification unit that verifies whether or not the first encryption information matches the second encryption information.

According to another aspect of the present disclosure, there is provided a signal processing method including transmitting, from a second processing unit to a first processing unit, sensing data and first encryption information obtained by encrypting a part of the sensing data or adding authentication information to the part of the sensing data, in which the second processing unit generates the first encryption information by encrypting a part of data randomly selected from the sensing data according to a random number generation procedure shared with the first processing unit, and the first processing unit generates second encryption information by encrypting a part of data randomly selected from the sensing data received from the second processing unit according to the random number generation procedure or adding authentication information to the part of data, and verifies whether or not the first encryption information matches the second encryption information.

### BRIEF DESCRIPTION OF DRAWINGS

FIG. 1 is a diagram illustrating a signal processing device according to a first embodiment.

FIG. 2 is a diagram illustrating an encryption region and a non-encryption region of a still image subjected to encryption processing.

FIG. 3 is a diagram illustrating a difference between an encryption region and a non-encryption region of a plurality of the still images.

FIG. 4 is a flowchart illustrating an example of processing of the signal processing device according to the first embodiment.

FIG. 5 is a flowchart illustrating an example of processing of an Soc according to the first embodiment.

FIG. 6 is a diagram illustrating a signal processing device as a modification according to the first embodiment.

FIG. 7 is a diagram illustrating a signal processing device as a modification according to the first embodiment.

FIG. 8 is a diagram illustrating a trust monitoring system according to a second embodiment.

FIG. 9 is a block diagram illustrating a configuration example of a vehicle control system.

FIG. 10 is a diagram illustrating an example of a sensing area.

### MODE FOR CARRYING OUT THE INVENTION

Hereinafter, embodiments of the present disclosure will be described in detail with reference to the drawings. In one or more embodiments described in the present disclosure, components included in each of the embodiments can be combined with each other, and the combined resultant also forms part of the embodiments described in the present disclosure.

### First Embodiment

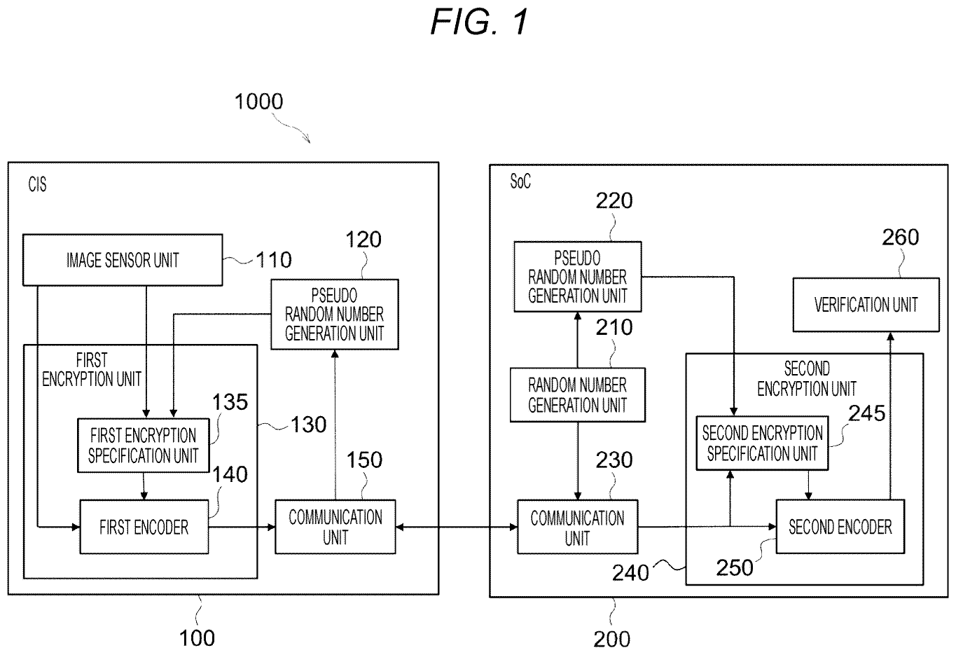

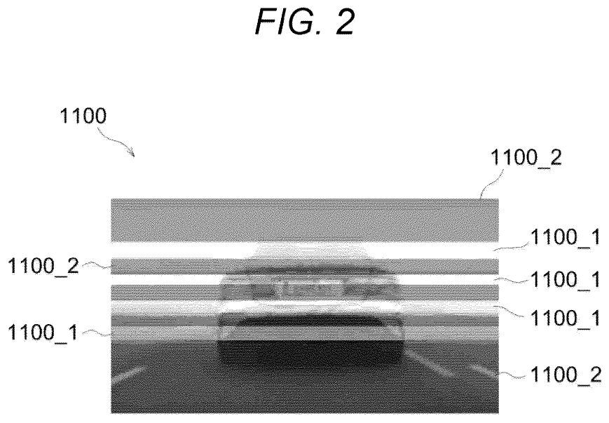

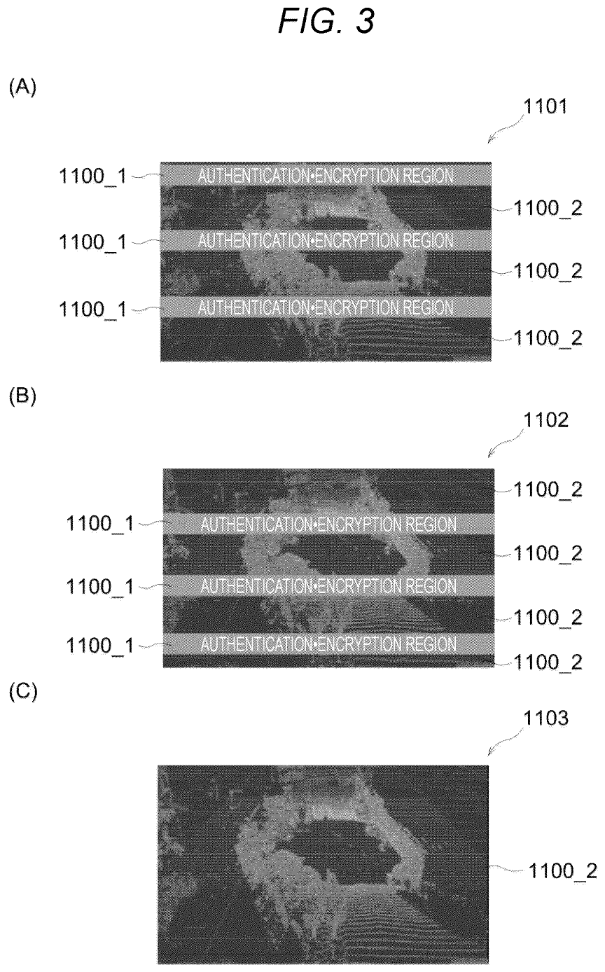

FIG. 1 illustrates a signal processing device 1000 according to a first embodiment of the present disclosure. FIG. 2 illustrates an encryption region and a non-encryption region of a still image subjected to encryption processing. FIG. 3 illustrates a difference between an encryption region and a non-encryption region of a plurality of the still images.

The signal processing device 1000 is, for example, a processing device that processes an image captured by an in-vehicle camera. Note that the signal processing device 1000 may be used for the purpose of processing an image other than an image captured by an in-vehicle camera, but an example of processing the image captured by the in-vehicle camera will be mainly described below.

Here, in the present specification, image data is interpreted by being included in sensing data. The sensing data includes not only the image data but also data detected by various sensors. Furthermore, the signal processing device 1000 may process various sensing data other than images.

As described above, various sensing devices that acquire or detect various sensing data may be connected to the signal processing device 1000, but an example in which a sensor that acquires image data is connected to the signal processing device 1000 will be mainly described below.

Furthermore, an example in which the signal processing device 1000 encrypts the image data when adding an authentication code to the image data will be described below, but the authentication code may be added without encrypting the image data.

The signal processing device 1000 includes a CMOS image sensor (CIS) 100 (second processing unit) and a system-on-chip (SoC) 200 (first processing unit).

The SoC 200 includes a pseudo random number generation unit (first random number generation unit) 220, a second encryption unit 240, and a communication unit 230. The CIS 100 includes a pseudo random number generation unit (second random number generation unit) 120, a first encryption unit 130, and a communication unit 150. Hereinafter, the internal configuration of the CIS 100 will be described first, and then the internal configuration of the SoC 200 will be described.

The CIS 100 is an imaging sensor that outputs sensing data including image data. The CIS 100 is built in, for example, an in-vehicle camera.

In the first embodiment, an example of an in-vehicle camera incorporating the CIS 100 that captures still images at a regular time interval will be mainly described. The in-vehicle camera may be a video camera that captures and outputs a moving image. Since a moving image includes a combination of a plurality of still images, processing of a still image will be described below even for a camera that captures a moving image.

Furthermore, the in-vehicle camera may be a light imaging detection and ranging (LiDAR) that generates a distance image from a distance measurement sensor that generates distance image data.

An image sensor unit 110 transmits the captured image data to the first encryption unit 130.

The first encryption unit 130 generates first encryption information by encrypting a part of data randomly selected from the sensing data according to a random number generation procedure shared with the SoC 200 or adding authentication information to the part of data. As described above, the sensing data is, for example, image data. In order to randomly select a part of an image region from the image data, for example, a pseudo random number can be used. The CIS 100 in FIG. 1 includes the pseudo random number generation unit 120.

The pseudo random number generation unit 120 generates a pseudo random number on the basis of input seed information. The seed information is generated by the SoC 200, for example, and is shared with the CIS 100.

The pseudo random number generation unit 120 in the CIS 100 generates a pseudo random number according to a random number generation procedure common to the pseudo random number generation unit 220 in the SoC 200. The common random number generation procedure means that an algorithm for generating the pseudo random number is common, and the seed information given to the algorithm and an update cycle of the pseudo random number are Common. Therefore, the pseudo random numbers generated by the pseudo random number generation units 120 and 220 at certain timings are the same, and the cycles at which the pseudo random number generation units 120 and 220 update the pseudo random numbers are also the same.

The pseudo random number generation unit 120 receives the seed information from the SoC 200 via the communication unit 150, for example, and generates a pseudo random number using the received seed information. As described later, the CIS 100 shares the seed information and a shared key with the SoC 200. The shared key is, for example, a secret key that can be known only by the SoC 200 and the CIS 100.

For example, the pseudo random number generation units 120 and 220 generate a pseudo random number by performing predetermined arithmetic processing using the seed information and the shared key. The pseudo random number generation units 120 and 220 may include a counter that performs a counting operation in synchronization with each other, and may update the pseudo random number in synchronization with a timing at which the counter performs the counting operation. When a value of the counter is different by one, completely different pseudo random numbers can be generated. The pseudo random number generation unit 120 transmits the generated pseudo random number to the first encryption unit 130.

The pseudo random numbers generated by the pseudo random number generation units 120 and 220 may not be random numbers in a strict sense, but in the present. specification, the pseudo random numbers generated by the pseudo random number generation units 120 and 220 may be simply referred to as random numbers.

On the basis of the pseudo random number generated by the pseudo random number generation unit 120, the first encryption unit 130 extracts and encrypts a part of image data in the image data acquired by the image sensor unit 110 and generates first encryption information.

The first encryption unit 130 includes a first encryption specification unit 135 and a first encoder 140. The first encryption specification unit 135 specifies sensing data to be encrypted on the basis of the pseudo random number generated by the pseudo random number generation unit 120. For example, in a case where the sensing data is image data, the first encryption specification unit 135 randomly selects a part of an image region in an image for one frame on the basis of the pseudo random number. Furthermore, the first encryption specification unit 135 may randomly select some frame images by the pseudo random number from among images (hereinafter, a plurality of frame images) for a plurality of frames.

Alternatively, the first encryption specification unit 135 may randomly select some frame images from the plurality of frame images by a pseudo random number, and randomly select some image regions in the selected frame images on the basis of a pseudo random number. In this case, the pseudo random number used to randomly select the some frame images from the plurality of frame images and the pseudo random number used to randomly select the some image regions in the selected frame images may be the same or different. As described above, the pseudo random number generation unit 120 may generate a plurality of kinds of pseudo random numbers at the same timing.

The first encoder 140 generates first encryption information by encrypting the image data specified by the first encryption specification unit 135 or adding authentication information to the image data. As a more specific example, the first encoder 140 generates coded data by performing encoding processing using a message authentication code (CMAC) on the image data specified by the first encryption specification unit 135. The coded data corresponds to the first encryption information generated by the first encryption unit 130. The first. encoder 140 transmits, to the communication unit 150, data obtained by adding the above-described coded data (first encryption information) to the image data acquired by the image sensor unit 110.

The first encoder 140 may generate coded data by encoding processing other than the CMAC. For example, the first encoder 140 may encode the image data specified by the first encryption specification unit 135 using a hash function.

The communication unit 150 transmits the first encryption information generated by the first encryption unit 130 and the image data acquired by the image sensor unit 110 to the Soc 200 in association with each other.

The communication unit 150 may further encrypt the first encryption information using the above-described shared key, pseudo random number, or the like, and transmit the first encryption information to the Soc 200.

FIG. 2 illustrates an example of first encryption information generated by the first encryption unit 130.

A frame image 1100 in FIG. 2 includes a plurality of encryption regions 1100_1 and a plurality of non-encryption regions 1100_2 in one frame image 1100. The plurality of encryption regions 1100_1 and the plurality of non-encryption regions 1100_2 are alternately arranged along a vertical direction of the frame image, but the positions and sizes in the vertical direction in which the plurality of encryption regions 1100_1 are arranged are random.

Furthermore, in the example of FIG. 2, three encryption regions 1100_1 are included in one frame image 1100, but the number of encryption regions 1100_1 included in the frame image is randomly selected.

In the example of FIG. 2, each encryption region 1100_1 extends from the left end to the right end in a horizontal direction, but may include only a part of an image region randomly selected in the horizontal direction. As described above, the first encryption specification unit 135 selects image regions of arbitrary positions, sizes, and numbers in the frame image 1100 on the basis of the pseudo random number.

FIG. 3 illustrates an encryption region 1100_1 and a non-encryption region 1100_2 in each of a plurality of frame images 1101 to 1103 constituting a moving image.

The plurality of frame images 1101 to 1103 are images of frames aligned continuously.

In FIG. 3(A) and 3(B), the positions of the encryption regions 1100_1 in the frame images 1101 and 1102 are different. Although FIG. 3(A) and 3(B) each include three encryption regions 1100_1, the number of encryption regions 1100_1 may be randomly selected for each frame as described above. Furthermore, as illustrated in FIG. 3(C), there may be a frame in which the encryption region 1100_1 does not exist in the frame image.

Also in the example of FIG. 3, the encryption region 1100_1 may be generated by randomly selecting a part of the image region in the horizontal direction in the frame image.

As described above, the first encryption unit 130 can randomly select vertical positions, horizontal positions, areas,, and the number of encryption regions 1100_1 in the frame image by the pseudo random number.

At that time, the positions, the areas, and the like of the encryption regions 1100_1 may be selected by the same pseudo random number, or the positions, the areas, and the like of the encryption regions 1100_1 may be selected by a pseudo random number different for each.

The SoC 200 detects falsification of the sensing data transmitted from the CIS 100. The second encryption unit 240 in the SoC 200 generates, from the sensing data received from the CIS 100, second encryption information by encrypting a part of data randomly selected according to a random number generation procedure shared with the CIS 100 or adding authentication information to the part of data. In a case where the sensing data is image data, the second encryption unit 240 generates second encryption information by encrypting a part of image data randomly selected from the image data received from the CIS 100 or adding authentication information to the part of the image data.

A pseudo random number can be used to randomly select a part of the image data. The SoC 200 of FIG. 1 includes the pseudo random number generation unit 220.

The pseudo random number generation unit 220 generates a pseudo random number according to a random number generation procedure shared with the CIS 100. As described above, the pseudo random numbers generated by the pseudo random number generation units 120 and 220 at certain timings are the same.

The pseudo random number generation unit 220 generates a pseudo random number by using, for example, seed information and a shared key. Randomizing the seed information increases confidentiality of the pseudo random number. Therefore, the SOC 200 in FIG. 1 uses a random number generated by a random number generation unit (third random number generation unit) 210 as seed information. The pseudo random number generation unit 220 generates a pseudo random number according to a random number generation procedure shared with the Soc 200 by using the random number generated by the random number generation unit 210 and the shared key.

The random number generated by the random number generation unit 210 is transmitted to the CIS 100 via the communication unit 230. The CIS 100 and the SoC 200 update a count value of the counter (not illustrated) according to a random number generation procedure shared with each other using the random number generated by the random number generation unit 210 and the key information. As a result, a pseudo random number corresponding to the count value is generated.

The second encryption unit 240 includes a second encryption specification unit 245 and a second encoder 250. The second encryption specification unit 245 specifies sensing data to be encrypted on the basis of the pseudo random number generated by the pseudo random number generation unit 220. More specifically, the second encryption specification unit 245 specifies the same image data as the image data specified by the first encryption specification unit 135 in the SoC 200.

The second encoder 250 generates second encryption information by encrypting the image data specified by the second encryption specification unit 245 or adding authentication information to the image data. The second encoder 250 generates the second encryption information by the same encoding processing as that of the first encoder 140.

A verification unit 260 verifies whether or not the first encryption information matches the second encryption information. When the image data transmitted from the CIS 100 to the SoC 200 has not been falsified, the verification in the verification unit 260 should match. Therefore, when the matching is verified by the verification unit 260, it can be concluded that the image data has not been falsified when the image data is transmitted from the CIS 100 to the SoC 200.

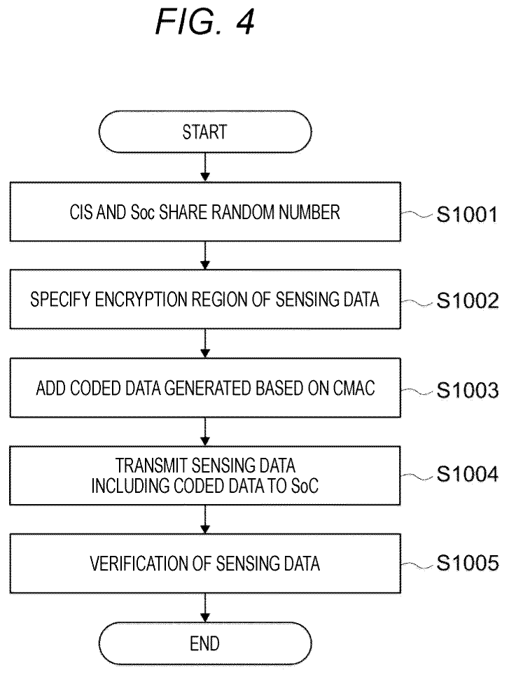

FIG. 4 is a flowchart illustrating an example of processing of the signal processing device 1000 according to the embodiment of the present disclosure.

The Soc 200 shares the random number by transmitting the random number generated by the random number generation unit 210 to the CIS 100 via the communication unit 230. (S1001).

The pseudo random number generation unit 120 in the CIS 100 generates a pseudo random number using the received random number as seed information. The first encryption specification unit 135 in the CIS 100 specifies an encryption region of the image data using the pseudo random number (S1002).

The first encoder 140 in the CIS 100 generates coded data by CMAC, for example, for image data Corresponding to the specified encryption region. The generated coded data is added to the sensing data as first encryption information (S1003).

The CIS 100 transmits the sensing data to which the coded data is added to the SoC 200 (S1004).

The pseudo random number generation unit 220 in the SoC 200 generates a pseudo random number from the same random number as the random number transmitted to the CIS 100. The second encryption specification unit 245 in the SoC 200 specifies an encryption region of the image data using the pseudo random number.

The second encoder 250 in the SoC200 generates coded data by CMAC, which is the same algorithm as the CIS100, for the image data corresponding to the specified encryption region.

The verification unit 260 in the SoC 200 compares the generated coded data with the coded data added to the sensing data transmitted from the CIS 100, and verifies whether or not there is falsification (S1005).

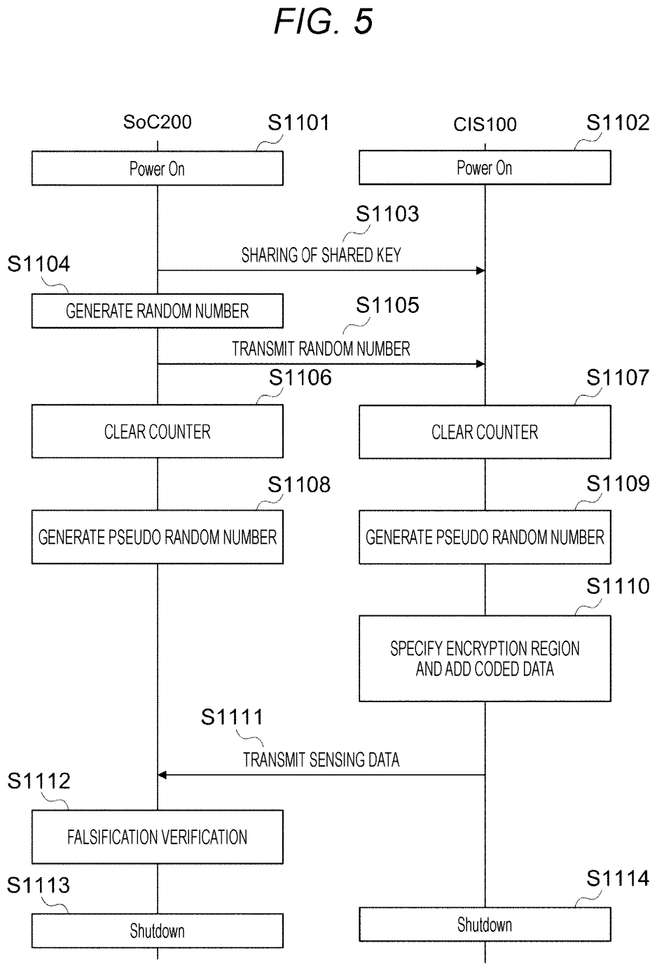

FIG. 5 is a sequence diagram illustrating an example of communication processing between the SoC 200 and the CIS 100 according to the embodiment of the present disclosure.

The SoC 200 first activates a power supply (S1101). Similarly, the CIS 100 activates a power supply (S1102).

The SoC 200 transmits and shares a shared key for encrypting communication with the CIS 100 (S1103).

The SoC 200 causes the random number generation unit 210 to generate a random number (S1104). The Soc 200 transmits the generated random number to the CIS 100 (S1105).

The SoC 200 clears the counter of the pseudo random number generation unit 220 (S1106). Similarly, the CIS 100 clears the counter of the pseudo random number generation unit 120 (S1107).

The SoC 200 updates the counter according to a random number generation procedure shared with the CIS 100 by using the generated random number and the shared key, and the pseudo random number generation unit 220 generates a pseudo random number on the basis of the updated count value (S1108). Similarly, the CIS 100 updates the counter according to the above-described random number generation procedure using the generated random number and the shared key, and the pseudo random number generation unit 120 generates a pseudo random number on the basis of the updated count value (S1109).

The first encryption specification unit 135 in the CIS 100 specifies an image region to be encrypted on the basis of the generated pseudo random number. The first encoder 140 in the CIS 100 generates coded data by encrypting the image region specified by the first encryption specification unit 135 or adding authentication information to the image region (S1110).

The first encryption unit 130 adds coded data (first encryption information) to the image data acquired by the image sensor unit 110 and outputs the image data.

The communication unit 150 in the CIS 100 adds coded data to the image data acquired by the image sensor unit 110 and transmits the image data to the SoC 200. At this time, encrypted communication may be performed using the shared key or the pseudo random number (S1111).

The SoC 200 verifies the transmitted sensing data by the verification unit 260 (81112). Specifically, the second encryption specification unit 245 in the SoC 200 performs processing similar to that of the first encryption specification unit 135 by using the pseudo random number generated by the pseudo random number generation unit 220 and the shared key, and specifies an image region to be encrypted. Next, the second encoder 250 generates coded data (second encryption information) for the specified image region. Next, the verification unit 260 verifies whether or not the first encryption information received from the CIS 100 matches the second encryption information generated by the second encoder 250.

The SoC 200 shuts down after the verification is completed (S1113). Similarly, the CIS 100 shuts down after completion of the verification (S1114).

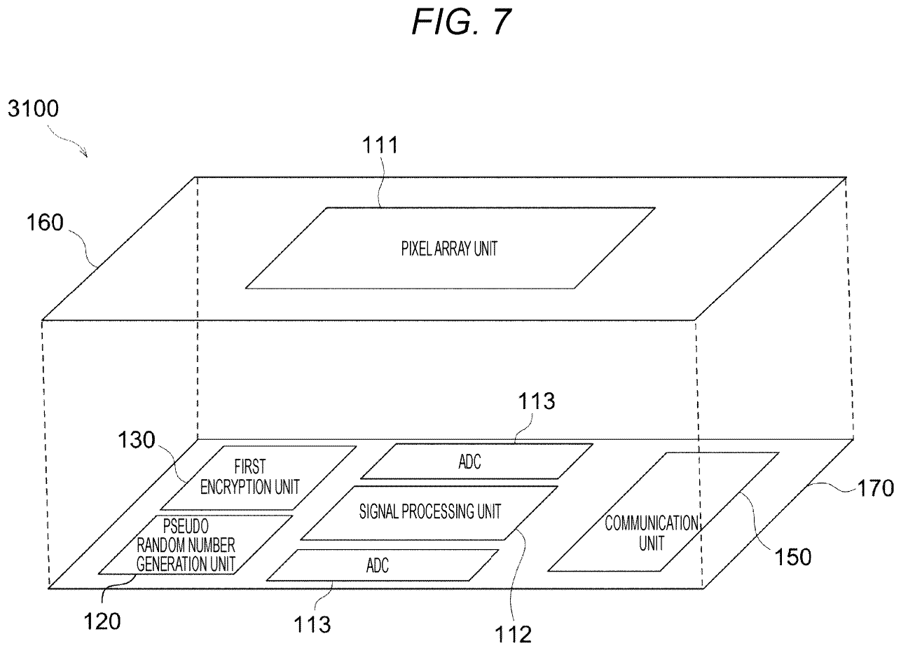

The processing of the pseudo random number generation unit 120 and the first encryption unit 130 in the CIS 100 of FIG. 1 may be executed by hardware or may be executed by software. In the case of execution by hardware, as illustrated in FIG. 7, a circuit that performs processing of the pseudo random number generation unit 120 and a circuit that performs processing of the first encryption unit 130 are only required to be formed on a semiconductor substrate of the CIS 100. The pseudo random number generation unit 120 and the first encryption unit 130 can be configured by a digital circuit such as a logical operation gate or a flip-flop.

In a case where the processing of the pseudo random number generation unit 120 and the first encryption unit 130 is executed by software, a signal processing processor and a semiconductor memory in which a program code for realizing the processing of the pseudo random number generation unit 120 and the first encryption unit 130 is stored are mounted on a semiconductor substrate, and the signal processing processor executes the program code to execute the processing of the pseudo random number generation unit 120 and the first encryption unit 130.

Similarly, in a case where the processing of the pseudo random number generation unit 220, the second encryption unit 240, and the verification unit 260 in the SoC 200 in FIG. 1 is executed by hardware, a circuit that performs the processing of the pseudo random number generation unit 220 and a circuit that performs the processing of the second encryption unit 240 are only required to be formed on a semiconductor substrate of the Soc 200. The pseudo random number generation unit 220 and the second encryption unit 240 can be configured by a digital circuit such as a logical operation gate or a flip-flop.

In a case where the processing of the pseudo random number generation unit 220 and the second encryption unit 240 is executed by software, a signal processing processor and a semiconductor memory in which a program code for realizing the processing of the pseudo random number generation unit 220 and the second encryption unit 240 is stored are mounted on a semiconductor substrate, and the signal processing processor executes the program code to execute the processing of the pseudo random number generation unit 220 and the second encryption unit 240.

As described above, according to the first embodiment, since the Soc 200 and the CIS 100 share the random number and the shared key and also share the random number generation procedure for generating the pseudo random number, the Soc 200 and the CIS 100 can generate the same pseudo random number at the same timing.

The CIS 100 randomly selects an image region to be encrypted using the pseudo random number and generates the first encryption information. The first encryption information is transmitted to the SoC 200 together with the image data generated by the image sensor unit 110.

The second encryption unit 240 in the SoC 200 randomly selects image data to be encrypted from the received image data using the pseudo random number and generates the second encryption information. Therefore, the verification unit 260 in the SoC 200 verifies whether or not the first encryption information and the second encryption information match, and when the first encryption information and the second encryption information match, it can be determined that the image data has not been falsified at the time of image transmission.

As described above, according to the first embodiment, a part of the image data acquired by the image sensor unit 110 is randomly selected, and whether or not the image data is falsified can be reliably verified. Therefore, the image authentication processing can be performed without increasing a processing load on the CIS 100 and the SoC 200, and the security can be enhanced.

### Modification 1

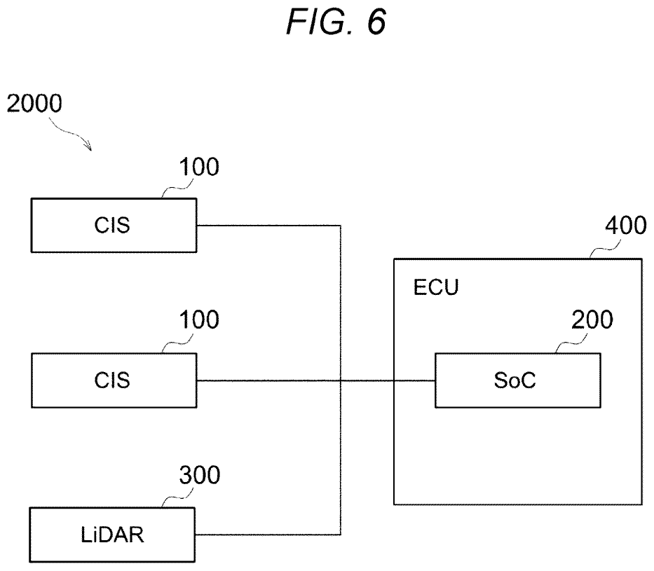

FIG. 6 illustrates a signal processing device 2000 that is a modification of the embodiment of the present disclosure. In the above-described embodiment, one CIS 100 is connected to the SoC 200, but a plurality of the CISs 100 may be connected to one SoC 200 as illustrated in FIG. 6. In this case, each of the CISs 100 in FIG. 6 has an internal configuration similar to that of the CIS 100 in FIG. 1, and the SOC 200 in FIG. 6 has an internal configuration similar to that of the SoC 200 in FIG. 1.
The Soc 200 in FIG. 6 receives the image data and the first encryption information transmitted from each of the CISs 100, generates the second encryption information for each CIS 100, and the verification unit 260 performs verification for each CIS 100.

In the above-described embodiment, an example has been described in which image data such as a still image acquired by the image sensor unit 110 is transmitted to the SoC 200 as sensing data to perform the verification. However, arbitrary sensing data other than the image data may be transmitted to the SoC 200 together with the first encryption information to perform the verification. In FIG. 6, separately from the plurality of CISs 100, distance image data acquired by a LiDAR 300 may be transmitted to the SoC 200 together with the first encryption information to perform the verification. Note that only the LiDAR 300 may be connected to the SoC 200 to perform authentication as to whether or not the distance image data has been falsified.

In the first embodiment described above, the Soc 200 having a function of verifying image data has been described, but the SoC 200 may have various functions other than the verification of image data. For example, an ECU 400 may be provided with the function of the SoC 200 of FIG. 1.

### Modification 2

At least one of the CIS 100 and the SoC 200 can have a structure (semiconductor chip structure) in which a plurality of semiconductor chips is stacked. FIG. 7 is an example of a stacked structure of the CIS 100. The CIS 100 of FIG. 7 includes a first chip 160 and a second chip 170 stacked on each other. The first chip 160 and the second chip 170 perform bonding and signal transmission by Cu-Cu bonding, bumps, vias, or the like.

The image sensor unit 110 in FIG. 1 includes a pixel array unit 111, a signal processing unit 112, and an analog-digital converter (ADC) 113. The pixel array unit 111 is disposed on the first chip 160. In the second chip 170, the signal processing unit 112 and the ADC 113 in the image sensor unit 110 are disposed, and the pseudo random number generation unit 120, the first encryption unit 130, and the communication unit 150 in FIG. 1 are further disposed.

In this manner, by forming the CIS 100 in a stacked structure, the first encryption information can be generated without increasing a circuit area, and the signal processing device can be downsized.

### Second Embodiment

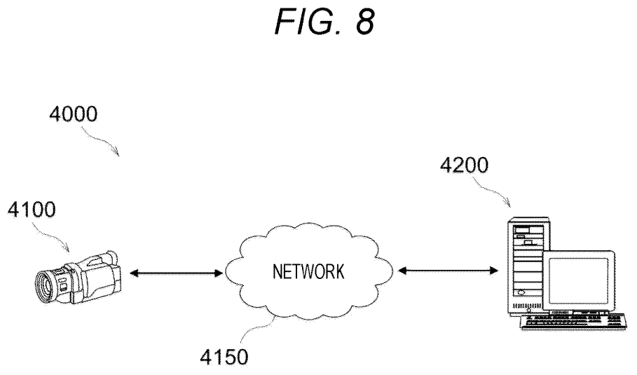

The signal processing device according to the present disclosure can be incorporated in a monitoring system. FIG. 8 illustrates a monitoring system 4000 including a signal processing device according to a second embodiment.

The monitoring system 4000 in FIG. 8 includes a monitoring camera 4100 including the CIS 100 in the first. embodiment and a server 4200 including the SoC 200 in the first embodiment.

The monitoring camera 4100 and the server 4200 can communicate with each other via a network 4150. The network 4150 may be a general-purpose network or a network dedicated to the monitoring system 4000.

Furthermore, the network 4150 may be wired or wireless.

The monitoring system 4000 in FIG. 8 acquires sensing data that is a moving image captured by the monitoring camera 4100. Since a moving image includes a plurality of still image data (image data) at a predetermined frame rate, image verification processing similar to that of the signal processing device according to the first embodiment can be performed.

By sharing the random number generated by the server 4200, the monitoring camera 4100 generates first encryption information by randomly selecting an image region from the image data, and transmits the first encryption information to the server 4200 via the network 4150 together with the image data.

The server 4200 generates second encryption information on the basis of the image data from the monitoring camera 4100, and verifies whether or not the first encryption information matches the second encryption information. Note that a computer device such as a personal computer (PC) or a worstation may be provided instead of the server 4200.

As described above, by incorporating the CIS 100 of FIG. 1 in the monitoring camera 4100 and incorporating the SoC 200 of FIG. 1 in the server 4200, it is possible to verify the image data using only a part of an image area of the image data captured by the monitoring camera 4100. According to the monitoring system 4000 of FIG. 8, it is possible to determine the presence or absence of falsification of the image data without increasing housing sizes of the monitoring camera 4100 and the server 4200 and without increasing a processing load on the monitoring camera 4100 and the server 4200.

Furthermore, the effects of the present disclosure described in the present specification are merely an example, and other effects may be achieved.

Note that the present invention is not limited to the embodiments described above as they are, and can be embodied by modifying the constituent elements without departing from the gist thereof in the implementation stage. Furthermore, various inventions can be formed by appropriately combining the plurality of constituent elements disclosed in the embodiments described above.

For example, some constituent elements may be deleted from all the constituent elements illustrated in the embodiments. Moreover, the constituent elements of different embodiments may be appropriately combined.

### Application Example

Hereinafter, an application example of a vehicle control system which is an example of a mobile device control system will be described. Note that a vehicle control system 11 described above can also be applied to any system, device, method, and the like of the following vehicle control system 11.

### 1. Configuration Example of Vehicle Control System

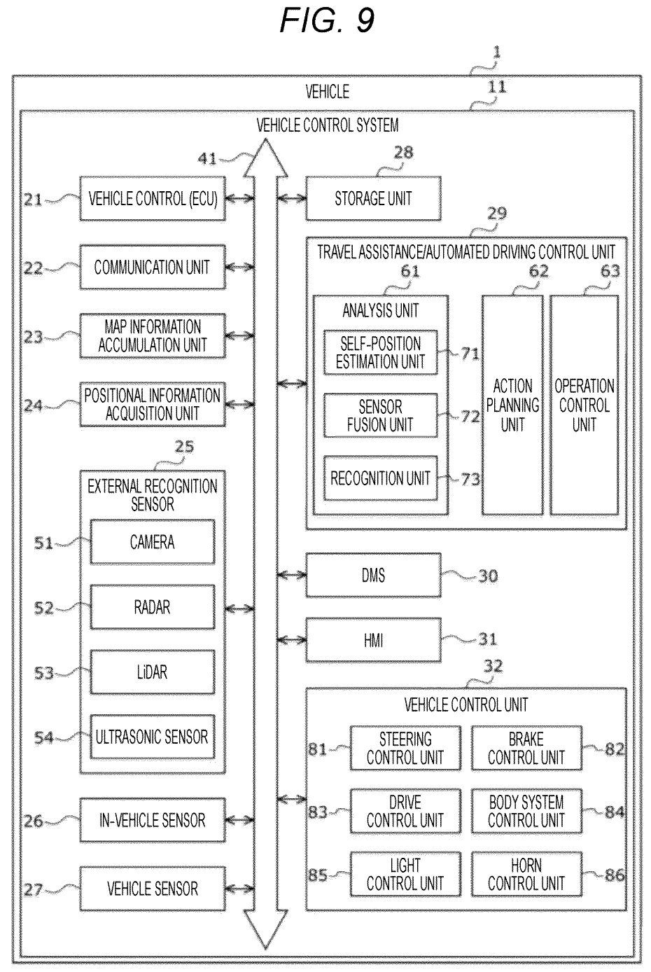

FIG. 9 is a block diagram illustrating a configuration example of a vehicle control system 11 that is an example of a mobile device control system to which the present technology is applied.

The vehicle control system 11 is provided in a vehicle 1, and performs processing relating to travel assistance and automated driving of the vehicle 1.

The vehicle control system 11 includes a vehicle control electronic control unit (ECU) 21, a communication unit 22, a map information accumulation unit 23, a positional information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the positional information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are interconnected so that communication can be performed via a communication network 41. The communication network 41 is formed with an in-vehicle communication network, a bus, and the like that conform to a digital bidirectional communication standard such as the controller area network (CAN), local interconnect network (LIN), local area network (LAN), FlexRay (registered trademark), or Ethernet (registered trademark), for example. The communication network 41 may be selectively used depending on the type of data to be transmitted. For example, the CAN may be applied to data related to vehicle control, and the Ethernet may be applied to large-volume data. Note that, in some cases, the respective components of the vehicle control system 11 are connected directly to each other not via the communication network 41, but with the use of wireless communication intended for a relatively short-range communication, such as near field communication (NFC) or Bluetooth (registered trademark), for example.

Note that, hereinafter, in a case where each component of the vehicle control system 11 performs communication via the communication network 41, explanation of the communication network 41 will be omitted. For example, in a case where the vehicle control ECU 21 and the communication unit 22 perform communication via the communication network 41, it will be simply described as the vehicle control ECU 21 and the communication unit 22 performing communication.

The vehicle control ECU 21 may be implemented by, for example, various processors, such as a central processing unit (CPU) and/or a microprocessing unit (MPU). The vehicle control ECU 21 controls all or a part of the functions of the vehicle control system 11.

The communication unit 22 communicates with many kinds of devices inside and outside the vehicle, another vehicle, a server, a base station, and the like, and sends and receives various kinds of data. In doing so, the communication unit 22 can perform communication using a plurality of communication schemes.

Communication that can be performed by the communication unit 22 with the outside of the vehicle is now briefly described. The communication unit 22 communicates with a server (hereinafter referred to as an external server) or the like present on an external network via a base station or an access point by a wireless communication system such as fifth generation mobile communication system (5G), long term evolution (LTE), dedicated short range communications (DSRC), or the like, for example. The external network with which the communication unit 22 performs communication include the Internet, a cloud network, a provider-specific network, or the like, for example. The communication scheme by which the communication unit 22 communicates with the external network is not limited to any particular method, as long as it is a wireless communication scheme that enables digital bidirectional communication at a communication speed equal to or higher than a predetermined speed and over a distance equal to or longer than a predetermined distance.

Also, the communication unit 22 can communicate with a terminal present in the vicinity of the host vehicle, using a peer to peer (P2P) technology, for example. The terminal present in the vicinity of the host vehicle is a terminal attached to a mobile object moving at a relatively low speed such as a pedestrian or a bicycle, a terminal stationarily installed in a store or the like, or a machine type communication (MTC) terminal, for example. Moreover, the communication unit 22 can also perform V2X communication. V2X communication refers to communication between the host vehicle and others, such as vehicle to vehicle communication with another vehicle, vehicle to infrastructure communication with a roadside device or the like, vehicle to home communication, and vehicle to pedestrian communication with a terminal or the like carried by a pedestrian, for example.

The communication unit 22 can receive a program for updating software that controls operations of the vehicle control system 11 from the outside (Over The Air), for example. The communication unit 22 can further receive map information, traffic information, information regarding the surroundings of the vehicle 1, and the like from the outside. Also, the communication unit 22 can send information regarding the vehicle 1, information about the surroundings of the vehicle 1, and the like to the outside, for example. The information regarding the vehicle 1 to be sent to the outside by the communication unit 22 is data indicating a state of the vehicle 1, a recognition result from a recognition unit 73, or the like, for example. Further, the communication unit 22 performs communication compatible with a vehicle emergency call system such as eCall, for example.

The communication unit 22 receives an electromagnetic wave sent by the vehicle information and communication system (VICS) (registered trademark) with a radio wave beacon, an optical beacon, frequency modulation (FM) multiplex broadcasting, or the like, for example.

Communication that can be performed by the communication unit 22 with the inside of the vehicle is now briefly described. The communication unit 22 can communicate with each device in the vehicle, using wireless communication, for example. The communication unit 22 can perform wireless communication with a device in the vehicle by a communication scheme allowing digital bidirectional communication at a communication speed equal to or higher than a predetermined speed by wireless communication, such as wireless LAN, Bluetooth, NFC, or wireless universal serial bus (WUSB), for example.

Besides this, the communication unit 22 can also communicate with each device in the vehicle, using wired communication. For example, the communication unit 22 can communicate with each device in the vehicle by wired communication via a cable connected to a connecting terminal not illustrated in the drawing. The communication unit 22 can communicate with each device in the vehicle by a communication scheme allowing digital bidirectional communication at a communication speed equal to or higher than a predetermined speed by wired communication, such as universal serial bus (USB), high-definition multimedia interface (HDMI) (registered trademark), or mobile high-definition link (MHL), for example.

Here, a device in the vehicle refers to a device that is not connected to the communication network 41 in the vehicle, for example. As the device in the vehicle, for example, a mobile device or a wearable device carried by an occupant such as a driver, an information device brought into the vehicle and temporarily installed, or the like is assumed.

The map information accumulation unit 23 accumulates either or both of a map acquired from the outside and a map created by the vehicle 1. For example, the map information accumulation unit 23 accumulates a three-dimensional high-precision map, a global map having a lower precision than the precision of the high-precision map but covering a wider area, and the like.

The high-precision map may be, for example, a dynamic map, a point cloud map, a vector map, or the like. The dynamic map is a map formed with four layers of dynamic information, semi-dynamic information, semi-static information, and static information, and is provided to the vehicle 1 from the external server or the like, for example. The point cloud map is a map formed with a point cloud (point cloud data). The vector map is a map obtained by associating traffic information such as lanes and the positions of traffic lights, and the like with a point cloud map, and adapting the associated point cloud map to the advanced driver assistance system (ADAS) or autonomous driving (AD), for example.

The point cloud map and the vector map may be, for example, provided from an external server or the like, or may be created by the vehicle 1 as a map to be matched with a local map to be described later on the basis of sensing results by a camera 51, a radar 52, a LiDAR 53, and the like, and may be accumulated in the map information accumulation unit 23. Alternatively, in a case where the high-precision map is provided from the external server or the like, for example, map data of several hundred meters square regarding a planned route on which the vehicle 1 is to travel from now on is acquired from the external server or the like to reduce the communication volume.

The positional information acquisition unit 24 receives a global navigation satellite system (GNSS) signal from a GNSS satellite, and acquires positional information about the vehicle 1. The acquired positional information is supplied to the travel assistance/automated driving control unit 29. Note that the positional information acquisition unit 24 is not necessarily a scheme using a GNSS signal, and may acquire positional information using a beacon, for example.

The external recognition sensor 25 includes various kinds of sensors that are used to recognize a situation outside the vehicle 1, and supplies sensor data from each sensor to each component of the vehicle control system 11. The external recognition sensor 25 may include any type and any number of sensors.

For example, the external recognition sensor 25 includes the camera 51, the radar 52, the light detection and ranging or laser imaging detection and ranging (LiDAR) 53, and an ultrasonic sensor 54. Besides this, the external recognition sensor 25 may have a configuration including one or more kinds of sensors among the camera 51, the radar 52, the LiDAR 53, and the ultrasonic sensor 54. The numbers of the cameras 51, the radars 52, the LiDARs 53, and the ultrasonic sensors 54 are not limited to any particular numbers, as long as the numbers represent installable numbers of sensors for the vehicle 1. Furthermore, the kinds of sensors included in the external recognition sensor 25 are not limited to this example, and the external recognition sensor 25 may include a sensor of some other type. An example of the sensing area of each sensor included in the external recognition sensor 25 will be described later.

Note that the imaging scheme of the camera 51 is not limited to any particular scheme. For example, cameras of various imaging schemes such as a time of flight (ToF) camera, a stereo camera, a monocular camera, and an infrared camera, which are of imaging schemes capable of distance measurement, can be used for the camera 51 as necessary. The camera 51 is not limited thereto and may be a camera for simply acquiring a Captured image regardless of distance measurement.

Furthermore, the external recognition sensor 25 can include an environmental sensor for detecting an environment of the vehicle 1, for example. The environmental sensor is a sensor for detecting an £ environment such as weather, climate, and brightness and can include various sensors such as a raindrop sensor, a fog sensor, a sunshine sensor, a snow sensor, and an illuminance sensor, for example.

Moreover, the external recognition sensor 25 includes a microphone that is used for detection and the like of a sound around the vehicle 1 or a position of a sound source, for example.

The in-vehicle sensor 26 includes various kinds of sensors for detecting information about the inside of the vehicle, and supplies sensor data from each sensor to each component of the vehicle control system 11. The type and number of the various sensors included in the in-vehicle sensor 26 are not particularly limited as long as the types and numbers allow practical installation of the sensors in the vehicle 1.

For example, the in-vehicle sensor 26 can include one or more types of sensors among a camera, a radar, a seating sensor, a steering wheel sensor, a microphone, and a biometric sensor. As the cameras included in the in-vehicle sensor 26, for example, cameras of various imaging schemes capable of measuring a distance, such as a ToF camera, a stereo camera, a monocular camera, and an infrared camera, can be used. The camera included in the in-vehicle sensor 26 is not limited thereto, and the camera may be a camera for simply acquiring a captured image regardless of distance measurement. The biometric sensor included in the in-vehicle sensor 26 is disposed on a seat, a steering wheel, or the like, for example, and detects various kinds of biological information about an occupant such as the driver.

The vehicle sensor 27 includes various sensors for detecting a state of the vehicle 1, and supplies sensor data from each sensor to each component of the vehicle control system 11. The type and number of the various sensors included in the vehicle sensor 27 are not particularly limited as long as the types and numbers allow practical installation of the sensors in the vehicle 1.

For example, the vehicle sensor 27 includes a speed sensor, an acceleration sensor, an angular velocity sensor (gyroscopic sensor), and an inertial measurement unit (IMU) obtained by integrating these sensors. For example, the vehicle sensor 27 includes a steering angle sensor that detects a steering angle of the steering wheel, a yaw rate sensor, an accelerator sensor that detects an operation amount of the accelerator pedal, and a brake sensor that detects an operation amount of the brake pedal. For example, the vehicle sensor 27 includes a rotation sensor that detects the number of rotations of the engine or the motor, an air pressure sensor that detects an air pressure of a tire, a slip rate sensor that detects a slip rate of the tire, and a wheel speed sensor that detects a rotation speed of a wheel. For example, the vehicle sensor 27 includes a battery sensor that detects a state of charge and temperature of the battery, and an impact sensor that detects an external impact.

The storage unit 28 includes at least one of a nonvolatile storage medium and a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be used as a storage medium. The storage unit 28 stores various kinds of programs and data to be used by the respective components of the vehicle control system 11. For example, the storage unit 28 includes an event data recorder (EDR) and a data storage system for automated driving (DSSAD), and stores information about the vehicle 1 before and after an event. such as an accident, and information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs an analysis process on the vehicle 1 and a situation around the vehicle 1.

The analysis unit 61 includes a self-position estimation unit 71, a sensor fusion unit 72, and the recognition unit 73.

The self-position estimation unit 71 estimates the self-position of the vehicle 1, on the basis of sensor data from the external recognition sensor 25 and the high-precision map accumulated in the map information accumulation unit 23. For example, the self-position estimation unit 71 generates a local map on the basis of sensor data from the external recognition sensor 25, and performs matching between the local map and the high-precision map, to estimate the self-position of the vehicle 1. The position of the vehicle 1 is based on the center of the axle for the pair of rear wheels, for example.

The local map is, for example, a three-dimensional high-precision map created using a technology such as simultaneous localization and mapping (SLAM), an occupancy grid map, or the like. The three-dimensional high-precision map is the above-described point cloud map or the like, for example. The occupancy grid map is a map in which a three-dimensional or two-dimensional space around the vehicle 1 is divided into grids (lattices) of a predetermined size, and an occupancy state of an object is indicated in units of grids. The occupancy state of the object is indicated by the presence/absence of existence probability of the object, for example. The local map is also used in a detection process and a recognition process for a situation outside the vehicle 1 by the recognition unit. 73, for example.

Note that, in some embodiments, the self-position estimation unit 71 may estimate the self-position of the vehicle 1 on the basis of the position information acquired by the positional information acquisition unit 24 and the sensor data from the vehicle sensor 27.

The sensor fusion unit 72 performs a sensor fusion process to obtain new information by combining a plurality of different kinds of sensor data (image data supplied from the camera 51 and sensor data supplied from the radar 52, for example). Methods for combining different types of sensor data include integration, fusion, correspondence, or the like.

The recognition unit 73 performs a detection process to detect a situation outside the vehicle 1, and a recognition process to recognize the situation outside the vehicle 1.

For example, the recognition unit 73 performs a detection process and a recognition process to detect and recognize a situation outside the vehicle 1, on the basis of information from the external recognition sensor 25, information from the self-position estimation unit 71, information from the sensor fusion unit 72, and the like.

Specifically, the recognition unit 73 performs a detection process, a recognition process, and the like to detect and recognize objects present around the vehicle 1, for example. An object detection process is a process of detecting the presence/absence, size, shape, position, motion, and the like of an object, for example. The object recognition processing is, for example, processing for recognizing an attribute such as a type of an object or identifying a specific object. The detection processing and the recognition processing, however, are not necessarily clearly separated and may overlap.

For example, the recognition unit 73 performs clustering to classify point clouds based on sensor data from the radar 52, the LiDAR 53, or the like into clusters of point clouds, to detect objects present around the vehicle 1. In this manner, the presence/absence, size, shape, and position of an object around the vehicle 1 are detected.

For example, the recognition unit 73 performs tracking to follow a motion of a cluster of point clouds classified by clustering, to detect a motion of an object present around the vehicle 1. In this manner, the speed and the traveling direction (movement vector) of an object present around the vehicle 1 are detected.

For example, the recognition unit 73 detects or recognizes a vehicle, a person, a bicycle, an obstacle, a structure, a road, a traffic light, a traffic sign, a road sign, and the like, on the basis of image data supplied from the camera 51. Furthermore, the recognition unit 73 may recognize the type of an object present around the vehicle 1 by performing a recognition process such as semantic segmentation.

For example, the recognition unit 73 can perform a recognition process to recognize traffic rules around the vehicle 1, on the basis of the map accumulated in the map information accumulation unit 23, a result of self-position estimation performed by the self-position estimation unit 71, and a result of an object recognition performed by the recognition unit 73 to recognize objects present around the vehicle 1. Through this process, the recognition unit 73 can recognize the positions and the states of traffic lights, the contents of traffic signs and road signs, the contents of the traffic regulations, the driving-allowed lanes, and the like.

For example, the recognition unit 73 can perform a recognition process to recognize the surrounding environment of the vehicle 1. The surrounding environment to be recognized by the recognition unit 73 may include weather, air temperature, humidity, brightness, road surface conditions, and the like.

The action planning unit 62 creates an action plan of the vehicle 1. For example, the action planning unit 62 creates an action plan by performing a path planning and path following process.

Note that the route planning (global path planning) is processing of planning a rough route from a start to a goal. This path planning includes a process of performing path generation (local path planning) called a path planning that enables safe and smooth traveling in the vicinity of the vehicle 1, with the motion characteristics of the vehicle 1 being taken into consideration in the planned path.

The path following is a process of planning an operation for safely and accurately traveling along a path planned by the path planning within a planned time. For example, the action planning unit 62 can calculate the target speed and the target angular velocity of the vehicle 1, on the basis of a result of the path following process.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 described later, and performs acceleration and deceleration control and direction control so that the vehicle 1 follows the path calculated by the local path planning. For example, the operation control unit 63 performs coordinated control to achieve ADAS functions such as collision avoidance or impact mitigation, follow-up running, vehicle-speed maintaining running, warning of collision of the host vehicle, warning of lane departure of the host vehicle, and the like. For example, the operation control unit 63 performs coordinated control to perform automated driving or the like in which the vehicle autonomously runs without depending on the operation by a driver.

The DMS 30 performs an authentication process on the driver, a recognition process on a state of the driver, and the like, on the basis of sensor data from the in-vehicle sensor 26, data input to the HMI 31 described later, and the like. The state of the driver to be recognized may be a physical condition, an alertness level, a concentration level, a fatigue level, a line-of-sight direction, a drunkenness level, a driving operation, a posture, or the like, for example.

Note that the DMS 30 may perform an authentication process on an occupant other than the driver, and a recognition process to recognize the state of the occupant. Furthermore, the DMS 30 may perform a recognition process to recognize the conditions inside the vehicle, on the basis of sensor data from the in-vehicle sensor 26, for example. As the situation in the vehicle to be recognized, for example, a temperature, a humidity, brightness, odor, or the like are assumed.

The HMI 31 receives inputs of various kinds of data, instructions, and the like, and presents various kinds of data to the driver and the like.

An input of data through the HMI 31 is now roughly described. The HMI 31 includes an input device for a person to input data. The HMI 31 generates an input signal on the basis of data, an instruction, or the like that has been input through the input device, and supplies the input signal to each component of the vehicle control system 11. The HMI 31 includes an operation element such as a touch panel, a button, a switch, and a lever as the input device, for example. In addition to this, the HMI 31 may further include an input device capable of inputting information by a method such as voice, gesture, or the like that is not a manual operation. Moreover, the HMI 31 may use a remote control device using infrared rays or radio waves, for example, or an external connection device such as a mobile device or a wearable device as an input device compatible with operations of the vehicle control system 11.

Presentation of data by the HMI 31 will be schematically described. The HMI 31 generates visual information, audio information, and haptic information regarding an occupant or the outside of a vehicle.

Furthermore, the HMI 31 performs output control to control outputting, output contents, an output timing, an output method, and the like of each piece of the generated information. The HMI 31 generates and outputs, as the visual information, information indicated by images or light of an operation screen, a display of the state of the vehicle 1, a warning display, a monitor image indicating a situation around the vehicle 1, and the like, for example. Furthermore, the HMI 31 generates and outputs, as the audio information, information indicated by sounds, such as voice guidance, a warning sound, and a warning message, for example. Moreover, the HMI 31 generates and outputs, as the haptic information, information to be given to the tactile sense of an occupant by force, vibration, motion, or the like, for example.

As the output device through which the HMI 31 outputs the visual information, a display device that presents the visual information by displaying an image, or a projector device that presents the visual information by projecting an image can be used, for example. Note that, other than a display device having a conventional display, the display device may be a device that displays the visual information in the field of view of an occupant, such as a head-up display, a transmissive display, or a wearable device having an augmented reality (AR) function, for example. Furthermore, in the HMI 31, a display device included in a navigation device, an instrument panel, a camera monitoring system (CMS), an electronic mirror, a lamp, or the like provided in the vehicle 1 can also be used as the output device that outputs the visual information.

As the output device through which the HMI 31 outputs the audio information, an audio speaker, headphones, or earphones can be used, for example.

As the output device through which the HMI 31 outputs the haptic information, a haptic element using a haptic technology can be used, for example. The haptic element is disposed at a portion to be touched by an occupant of the vehicle 1, such as the steering wheel or a seat, for example.

The vehicle control unit 32 controls each component of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of the steering system of the vehicle 1. The steering system includes, for example, a steering mechanism including a steering wheel and the like, an electric power steering, and/or the like. The steering control unit 81 includes, for example, a steering ECU that controls the steering system, an actuator that drives the steering system, and/or the like.

The brake control unit 82 performs detection, control, and the like of a state of the brake system of the vehicle 1. The brake system includes a brake mechanism including a brake pedal and the like, an antilock brake system (ABS), a regenerative brake mechanism, and the like, for example. The brake control unit 82 includes, for example, a brake ECU that controls the brake system, an actuator that drives the brake system, and/or the like.

The drive control unit 83 performs detection, control, and the like of a state of the drive system of the vehicle 1. The drive system includes, for example, an accelerator pedal, a driving force generation device for generating driving force for an internal combustion engine, a driving motor, or the like, a driving force transmission mechanism for transmitting the driving force to wheels, and/or the like. The drive control unit 83 includes, for example, a drive ECU that controls the drive system, an actuator that drives the drive system, and/or the like.

The body system control unit 84 performs detection, control, and the like of a state of the body system of the vehicle 1. The body system includes, for example, a keyless entry system, a smart key system, a power window device, a power seat, an air conditioner, an airbag, a seat belt, a shift lever, and/or the like. The body system control unit 84 includes, for example, a body system ECU that controls the body system, an actuator that drives the body system, and/or the like.

The light control unit 85 performs detection, control, and the like of states of various lights of the vehicle 1. The lights to be controlled may be the headlight, the backing light, a fog light, a turn signal, a brake light, a projection, a bumper display, and the like are assumed, for example. The light control unit 85 includes a light ECU that controls a light, an actuator that drives the light, and/or the like.

The horn control unit 86 performs detection, control, and the like of a state of the car horn of the vehicle 1. The horn control unit 86 includes, for example, a horn ECU that controls the car horn, an actuator that drives the car horn, and/or the like.

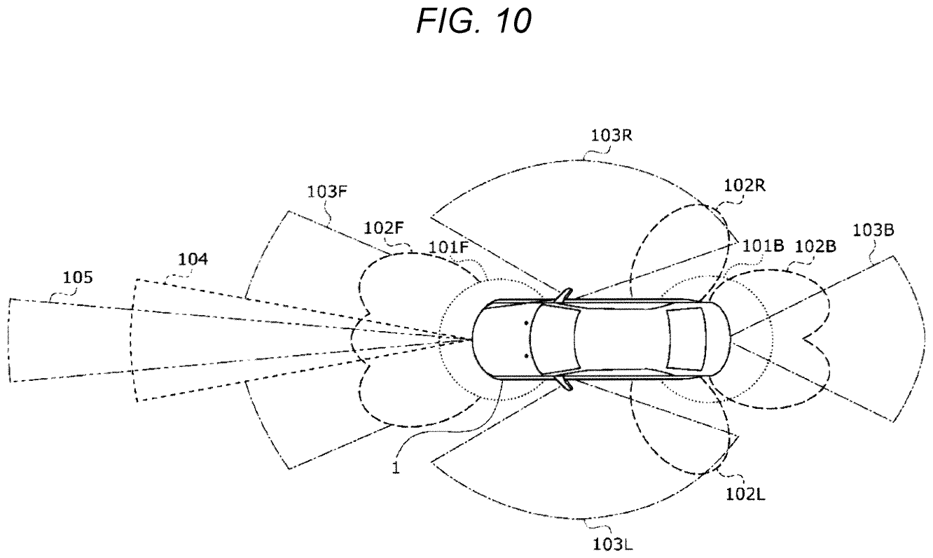

FIG. 10 is a diagram illustrating an example of a sensing area by the camera 51, the radar 52, the LiDAR 53, the ultrasonic sensor 54, and the like of the external recognition sensor 25 in FIG. 9. Note that FIG. 10 schematically illustrates the vehicle 1 as viewed from above, where the left end side is a front end (front) side of the vehicle 1 and the right end side is a rear end (rear) side of the vehicle 1.

A sensing area 101F and a sensing area 101B indicate examples of the sensing area of the ultrasonic sensor 54. The sensing area 101F covers an area around the front end of the vehicle 1 with a plurality of the ultrasonic sensors 54. The sensing area 101B covers an area around the rear end of the vehicle 1 with a plurality of the ultrasonic sensors 54.

Sensing results in the sensing area 101F and the sensing area 101B are used in parking assistance and the like for the vehicle 1, for example.

Sensing areas 102F to 102B indicate examples of the sensing area of short-range or medium-range radars 52.

The sensing area 102F covers an area extending to a position farther than the sensing area 101F in front of the vehicle 1. The sensing area 102B covers an area extending to a position farther than the sensing area 101B behind the vehicle 1. The sensing area 102L covers an area around the rear left side of the vehicle 1. The sensing area 102R covers an area around the rear right. side of the vehicle 1.

A sensing result in the sensing area 102F is used in detection and the like of a vehicle, a pedestrian, or the like present in front of the vehicle 1, for example. A sensing result in the sensing area 102B is used in a collision prevention function and the like behind the vehicle 1, for example. Sensing results in the sensing area 102L and the sensing area 102R are used in detection and the like of an object in a blind spot on the sides of the vehicle 1, for example Sensing areas 103F to 103B indicate examples of the sensing areas of the cameras 51. The sensing area 103F covers an area extending to a position farther than the sensing area 102F in front of the vehicle 1. The sensing area 103B covers an area extending to a position farther than the sensing area 102B behind the vehicle 1. The sensing area 103L covers an area around the left side of the vehicle 1. The sensing area 103R covers an area around the right side of the vehicle 1.

A sensing result in the sensing area 103F can be used in recognition of a traffic light or a traffic sign, a lane departure prevention assist system, and an automatic headlight control system, for example. A sensing result in the sensing area 103B can be used in parking assistance, a surround view system, and the like, for example. Sensing results in the sensing area 103L and the sensing area 103R can be used in a surround view system, for example.

A sensing area 104 indicates an example of a sensing area of the LiDAR 53. The sensing area 104 covers an area extending to a position farther than the sensing area 103F in front of the vehicle 1. However, the sensing area 104 has a narrower range in a lateral direction than the sensing area 103F.

A sensing result in the sensing area 104 is used in detection of an object such as a vehicle in the vicinity, for example.

A sensing area 105 indicates an example of the sensing area of the radar 52 for a long distance. The sensing area 105 covers an area extending to a position farther than the sensing area 104 in front of the vehicle 1. However, the sensing area 105 has a narrower range in a lateral direction than the sensing area 104.

A result of sensing in the sensing area 105 is used in adaptive cruise control (ACC), emergency braking, collision avoidance, and the like, for example.

Note that the sensing areas of the sensors of the camera 51, the radar 52, the LiDAR 53, and the ultrasonic sensor 54 included in the external recognition sensor 25 may have various configurations other than those in FIG. 10. Specifically, the ultrasonic sensors 54 may also perform sensing on the sides of the vehicle 1, or the LiDAR 53 may perform sensing behind the vehicle 1.

Furthermore, the installation position of each sensor is not limited to each corresponding example described above. Furthermore, the number of each sensor may be one or more.

Note that the present disclosure can also have the following configurations.

### Item 1

A signal processing device including:
a first processing unit; and
a second processing unit that transmits, to the first processing unit, sensing data and first encryption information obtained by encrypting a part of the sensing data,
in which the second processing unit includes
a first encryption unit that generates the first encryption information by encrypting a part of data randomly selected from the sensing data according to a random number generation procedure shared with the first processing unit or adding authentication information to the part of data, and
the first processing unit includes:
a second encryption unit that generates second encryption information by encrypting a part of data randomly selected from the sensing data received from the second processing unit according to the random number generation procedure or adding authentication information to the part of data; and
a verification unit that verifies whether or not the first encryption information matches the second encryption information.

### Item 2

The signal processing device according to item 1, in which
the first encryption unit and the second encryption unit randomly select timings at which the first encryption information and the second encryption information are generated according to the random number generation procedure.

### Item 3

The signal processing device according to item 1 or 2, in which
the first encryption unit generates the first encryption information from a part of the sensing data acquired at a timing randomly selected according to the random number generation procedure, and
the second encryption unit generates the second encryption information from a part of the sensing data acquired at a timing randomly selected according to the random number generation procedure among the sensing data received from the second processing unit.

### Item 4

The signal processing device according to any one of items 1 to 3, in which
the first processing unit acquires a plurality of the sensing data at a predetermined time interval, and
the first encryption unit generates the first encryption information by encrypting the part of data randomly selected from each of the plurality of sensing data or adding authentication information to the part of data.

### Item 5

The signal processing device according to any one of items 1 to 4, in which
the first processing unit acquires a plurality of the sensing data at a predetermined time interval, and
the first encryption unit generates the first encryption information on the basis of sensing data at a time interval randomly selected from the plurality of sensing data.

### Item 6

The signal processing device according to item 5, in which
the first encryption unit generates the first encryption information by randomly selecting the part of data included in the sensing data at a time interval randomly selected from the plurality of sensing data.

### Item 7

The signal processing device according to item 5 or 6, in which
the first processing unit includes a first random number generation unit that generates a first random number according to the random number generation procedure,
the second processing unit includes a second random number generation unit that generates a second random number according to the random number generation procedure,
the first encryption unit generates the first encryption information on the basis of the first random number, and
the second encryption unit generates the second encryption information on the basis of the second random number.

### Item 8

The signal processing device according to item 7, in which
the first random number generation unit generates the first random number according to the random number generation procedure by using key information and a third random number shared between the first processing unit and the second processing unit, and
the second random number generation unit generates the second random number according to the random number generation procedure by using the key information and the third random number.

### Item 9

The signal processing device according to item 8, in which
the first processing unit includes:
a third random number generation unit that generates the third random number; and
a communication unit that transmits the third random number to the second processing unit.

### Item 10

The signal processing device according to any one of items 7 to 9, in which
the sensing data includes image data, and
the first encryption unit generates the first encryption information by encrypting the part of data included in the image data on the basis of the first random number or adding authentication information to the part of data.

### Item

11

The signal processing device according to item 10, in which
the first processing unit acquires a plurality of the image data at a predetermined time interval, and
the first encryption unit generates the first encryption information by randomly selecting image data at a partial time interval among the plurality of image data.

### Item 12

The signal processing device according to item 11, in which
the first encryption unit generates the first encryption information by encrypting the part of data randomly selected from the part of image data or adding authentication information to the part of data.

### Item 13

The signal processing device according to any one of items 10 to 12, in which
the first processing unit includes an imaging sensor that detects the image data.

### Item 14

The signal processing device according to item 13, in which
the image data includes distance image data, and
the first processing unit includes a distance measurement sensor that generates the distance image data.

### Item 15

The signal processing device according to any one of items 7 to 14, in which
at least one of the first random number generation unit and the second random number generation unit is configured by hardware.

### Item 16

The signal processing device according to any one of items 7 to 15, in which
at least one of the first processing unit and the second processing unit performs processing of at least one of the first random number generation unit and the second random number generation unit by software.

### Item 17

The signal processing device according to any one of items 1 to 16, in which
the second processing unit has a stacked semiconductor chip structure in which at least two semiconductor chips are stacked.

### Item 18

A monitoring system including:
a first processing device; and
a second processing device that transmits, to the first processing device, sensing data and first encryption information obtained by encrypting a part of the sensing data or adding authentication information to the part of the sensing data,
in which the second processing device includes a first encryption unit that generates the first encryption information by encrypting a part of data randomly selected from the sensing data according to a random number generation procedure shared with the first processing device, and
the first processing device includes:
a second encryption unit that generates second encryption information by encrypting a part of data randomly selected from the sensing data received from the second processing device according to the random number generation procedure or adding authentication information to the part of data; and
a verification unit that verifies whether or not the first encryption information matches the second encryption information.

### Item 19

A signal processing method including transmitting,
from a second processing unit to a first processing unit,
sensing data and first encryption information obtained by encrypting a part of the sensing data,
in which the second processing unit generates the first encryption information by encrypting a part of data randomly selected from the sensing data according to a random number generation procedure shared with the first processing unit or adding authentication information to the part of data, and
the first processing unit
generates second encryption information by encrypting a part of data randomly selected from the sensing data received from the second processing unit according to the random number generation procedure or adding authentication information to the part of data, and
verifies whether or not the first encryption information matches the second encryption information.

### REFERENCE SIGNS LIST

1000, 2000, 3000 Signal processing device
4000 Monitoring system
110 Image sensor unit
111 Pixel array unit
112 Signal processing unit
113 ADC
120, 220 Pseudo random number generation unit
130 First encryption unit
140 First encoder
150, 230 Communication unit
240 Second encryption unit
245 Second encryption specification unit
250 Second encoder
1100_1 Encryption region
1100_2 Non-encryption region
1100, 1101, 1102, 1103 Frame image
400 ECU
3100 Cu-Cu bond
3201, 3301 Processor
3202, 3302 ADC
4100 Monitoring camera
4200 Server
1 Vehicle
11 Vehicle control system
21 Vehicle control electronic control unit (ECU)
22 Communication unit
23 Map information accumulation unit
24 Position information acquisition unit
25 External recognition sensor
26 In-vehicle sensor
27 Vehicle sensor
28 Storage unit
29 Travel assistance/automated driving control unit
30 Driver monitoring system (DMS)
31 Human machine interface (HMI)
32 Vehicle control unit
41 Communication network
51 Camera
52 Radar
53 LiDAR
54 Ultrasonic sensor
61 Analysis unit
62 Action planning unit
63 Operation control unit
71 Self-position estimation unit
72 Sensor fusion unit
73 Recognition unit
81 Steering control unit
82 Brake control unit
83 Drive control unit
84 Body system control unit
85 Light control unit
86 Horn control unit

1. A signal processing device comprising:
a first processing unit; and
a second processing unit that transmits, to the first processing unit, sensing data and first encryption information obtained by encrypting a part of the sensing data,
wherein the second processing unit includes
a first encryption unit that generates the first encryption information by encrypting a part of data randomly selected from the sensing data according to a random number generation procedure shared with the first processing unit or adding authentication information to the part of data, and
the first processing unit includes:
a second encryption unit that generates second encryption information by encrypting a part of data randomly selected from the sensing data received from the second processing unit according to the random number generation procedure or adding authentication information to the part of data; and
a verification unit that verifies whether or not the first encryption information matches the second encryption information.

2. The signal processing device according to claim 1, wherein
the first encryption unit and the second encryption unit randomly select timings at which the first encryption information and the second encryption information are generated according to the random number generation procedure.

3. The signal processing device according to claim 1, wherein
the first encryption unit generates the first encryption information from a part of the sensing data acquired at a timing randomly selected according to the random number generation procedure, and
the second encryption unit generates the second encryption information from a part of sensing data acquired at a timing randomly selected according to the random number generation procedure among the sensing data received from the second processing unit.

4. The signal processing device according to claim 1, wherein
the first processing unit acquires a plurality of the sensing data at a predetermined time interval, and
the first encryption unit generates the first encryption information by encrypting the part of data randomly selected from each of the plurality of sensing data or adding authentication information to the part of data.

5. The signal processing device according to claim 1, wherein
the first processing unit acquires a plurality of the sensing data at a predetermined time interval, and
the first encryption unit generates the first encryption information on a basis of sensing data at a time interval randomly selected from the plurality of sensing data.

6. The signal processing device according to claim 5, wherein
the first encryption unit generates the first encryption information by randomly selecting the part of data included in the sensing data at a time interval randomly selected from the plurality of sensing data.

7. The signal processing device according to claim 1, wherein
the first processing unit includes a first random number generation unit that generates a first random number according to the random number generation procedure,
the second processing unit includes a second random number generation unit that generates a second random number according to the random number generation procedure,
the first encryption unit generates the first encryption information on a basis of the first random number, and
the second encryption unit generates the second encryption information on a basis of the second random number.

8. The signal processing device according to claim 7, wherein
the first random number generation unit generates the first random number according to the random number generation procedure by using key information and a third random number shared between the first processing unit and the second processing unit, and
the second random number generation unit generates the second random number according to the random number generation procedure by using the key information and the third random number.

9. The signal processing device according to claim 8, wherein
the first processing unit includes:
a third random number generation unit that generates the third random number; and
a communication unit that transmits the third random number to the second processing unit.

10. The signal processing device according to claim 7, wherein
the sensing data includes image data, and
the first encryption unit generates the first encryption information by encrypting the part of data included in the image data on a basis of the first random number or adding authentication information to the part of data.

11. The signal processing device according to claim 10, wherein
the first processing unit acquires a plurality of the image data at a predetermined time interval, and
the first encryption unit generates the first encryption information by randomly selecting image data at a partial time interval among the plurality of image data.

12. The signal processing device according to claim 11, wherein
the first encryption unit generates the first encryption information by encrypting the part of data randomly selected from the part of image data or adding authentication information to the part of data.

13. The signal processing device according to claim 10, wherein
the first processing unit includes an imaging sensor that detects the image data.

14. The signal processing device according to claim 10, wherein
the image data includes distance image data, and
the first processing unit includes a distance measurement sensor that generates the distance image data.

15. The signal processing device according to claim 7, wherein
at least one of the first random number generation unit and the second random number generation unit is configured by hardware.

16. The signal processing device according to claim 7, wherein
at least one of the first processing unit and the second processing unit performs processing of at least one of the first random number generation unit and the second random number generation unit by software.

17. The signal processing device according to claim 1, wherein
the second processing unit has a stacked semiconductor chip structure in which at least two semiconductor chips are stacked.

18. A monitoring system comprising:
a first processing device; and
a second processing device that transmits, to the first processing device, sensing data and first encryption information obtained by encrypting a part of the sensing data or adding authentication information to the part of the sensing data,
wherein the second processing device includes a first encryption unit that generates the first encryption information by encrypting a part of data randomly selected from the sensing data according to a random number generation procedure shared with the first processing device or adding authentication information to the part of data, and
the first processing device includes:
a second encryption unit that generates second encryption information by encrypting a part of data randomly selected from the sensing data received from the second processing device according to the random number generation procedure or adding authentication information to the part of data; and
a verification unit that verifies whether or not the first encryption information matches the second encryption information.

19. A signal processing method comprising transmitting, from a second processing unit to a first processing unit, sensing data and first encryption information obtained by encrypting a part of the sensing data or adding authentication information to the part of the sensing data,
wherein the second processing unit
generates the first encryption information by encrypting a part of data randomly selected from the sensing data according to a random number generation procedure shared with the first processing unit or adding authentication information to the part of data, and
the first processing unit
generates second encryption information by encrypting a part of data randomly selected from the sensing data received from the second processing unit according to the random number generation procedure or adding authentication information to the part of data, and
verifies whether or not the first encryption information matches the second encryption information.
